(19) United States
(12) Patent Application Publication
(10) Pub. No.: US 2011/0083646 A1
(43) Pub. Date: Apr. 14, 2011

(54) Compressed Air Intake Engine Inlet Booster

(75) Inventors: Grzegorz Siuchta, Des Plaines, IL (US); Robert L. Rowells, Elmwood Park, IL (US)

(73) Assignee: International Engine Intellectual Property Company LLC, Warrenville, IL (US)

(21) Appl. No.: 12/703,546

(22) Filed: Feb. 10, 2010

Related U.S. Application Data
(60) Provisional application No. 61/250,334, filed on Oct. 9, 2009.

(51) Int. Cl. F02B 33/00; F02B 33/44

(52) U.S. Cl. 123/564; 60/598

(57) ABSTRACT

An inlet air booster system for increasing turbocharger response time by utilizing compressed air from an engine driven compressor. Compressed air used to supply air for air braking system is channeled into an air tank to provide a boost of compressed air into the intake manifold. The inlet air booster system comprises an air booster ring disposed around a manifold inlet supply pipe, an air supply source, and a control valve. Compressed air from the air tank flows along a compressed air supply pipe regulated by a control valve, which in its open position allows air flow to the air booster ring. The air booster ring comprises an air chamber and a plurality of nozzles angled towards the direction of intake gas flow to provide a burst of compressed air into the intake manifold. The angled flow of compressed air enhances the flow of intake air into the intake manifold.

### FIELD OF THE INVENTION

This invention relates to internal combustion engines, including but not limited to turbocharged engines.

### BACKGROUND

The United States and the European Union have proposed stricter diesel exhaust emission regulations. These environmental regulations require diesel engines to meet the same pollution emission standards as gasoline engines. Various methods, such as improving fuel efficiency can assist in lowering diesel emissions within acceptable ranges.

On a diesel engine operating at variable exhaust gas recirculation (EGR) rates for control of nitrous oxide (NOx) levels, the air/fuel ratio can fall to very low levels when trying to accelerate from idle. This can produce both a lower power condition, and a heavy smoke condition. EGR flow during the acceleration degrades turbocharger response time, a delay also known as “turbo lag.” Turbo lag occurs during the period of time when there is an increased power demand before the rotary compressor driven by the exhaust gas turbine reaches its full power capacity.

Prior art systems have attempted to overcome turbo lag by momentarily closing the EGR valve. However, the shutting off of the EGR will produce an increase in NOx levels which becomes significant when considering a .2gm/bph-hr limit. Lower NOx limits due to stricter diesel exhaust emissions regulations from the EPA makes the momentary closing of the EGR valve less desirable as a solution to decrease turbo lag.

Other prior art methods for reducing turbo lag are discussed in U.S. Pat. No. 6,178,749 and 5,771,695. U.S. Pat. No. 6,178,749 describes a method for reducing turbo lag comprising generating an EGR control signal for incrementally adjusting the position of the EGR valve and turbocharger turbine based on current intake manifold pressure and airflow, and the desired intake manifold pressure and airflow for the desired fueling rate. U.S. Pat. No. 5,771,695 describes a method for improving the time response of a turbo-compressor assisted internal combustion engine wherein the turbo-compressor is driven by an electric motor at a speed somewhat less than its full-load operating speed until such time as the turbo-compressor is driven at a higher speed by an exhaust gas turbine.

The present invention relates to a system for increasing the amount of air through a turbocharger to allow for a quicker turbocharger response. Pressurized air stored in an external tank, similar to pressurized air stored in air tanks for the air brake systems in trucks, is utilized to both supplement the turbocharger supplied air flow, and encourage air flow through the turbocharger toward the intake manifold, allowing the turbocharger to respond more rapidly during acceleration from idle, without requiring the closing of the EGR valve.

Air compression systems have long been used on trucks and other commercial vehicles to power air brakes, and other air operated auxiliaries such as an air clutch system. The vehicle air system has an air compressor which supplies air to a wet tank in fluid connection with additional air tanks, which may be assembled according to U.S. Pat. No. 6,082,408. The engine driven compressor is powered by the crankshaft pulley via a belt, or directly off of the engine timing gears. Compressed air is usually cooled by passing the air through a cooling coil, and into an air dryer to remove moisture, oil, and other impurities before it reaches a purge reservoir or wet tank.

Air brake compressors operate continuously to fill air tanks to a predetermined pressure, usually 120 psi. Once the tanks are brought up to pressure, excess air is regulated off. This excess air, known as “waste air”, is used in the present invention to pressurize an additional air tank in order to provide a boost of air supply into the intake manifold.

The present inventors have recognized the need for system that allows for improved engine efficiency and provides a quicker turbocharger response time while maintaining NOx emissions at levels within diesel emission regulation guidelines.

The present inventors have recognized the need for a system that utilizes waste energy in the form of air from the air braking system to improve performance, and reduce trap soot loading without interfering with normal engine operation.

The present inventors have recognized the need for an invention that helps meet EPA emission standards by improving fuel consumption to lower CO2 emissions while preventing turbocharger lag.

### SUMMARY

An exemplary embodiment of the invention provides an inlet air booster system that allows for the introduction of air into the intake manifold. The system uses an external air tank that is charged by the engine driven compressor used for charging the vehicles air brake tanks The booster system is positioned close to the inlet of the intake manifold.

An exemplary embodiment of the invention provides an inlet air booster system comprising an inlet air booster ring, a control valve, and a source of air supply. The inlet air booster ring is disposed around a manifold inlet supply pipe. The air flow from the air tank to the air booster ring is controlled by a high volume control valve. Control of the high volume control valve is integrated into the engine management computer (EMC).

An exemplary method of the invention for operating the booster system in an engine includes the steps of:

providing a compressed air tank connected to a compressed air supply pipe, the pipe comprising a control valve downstream of the air tank;

providing an air booster ring disposed around a manifold intake supply pipe;

providing a signal from the engine management computer to open the control valve when a driver presses down on the throttle to accelerate;

providing a supply of air into the manifold inlet supply pipe when the control valve is in its opened position.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a schematic diagram of a turbocharged engine.

FIG. 2 is a schematic diagram of a turbocharged engine with the booster system of the present invention.

FIG. 3 is a schematic diagram of the air booster ring.

FIG. 4 is a schematic diagram of one embodiment of a control system that may be used with the inlet air booster system of the present invention.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

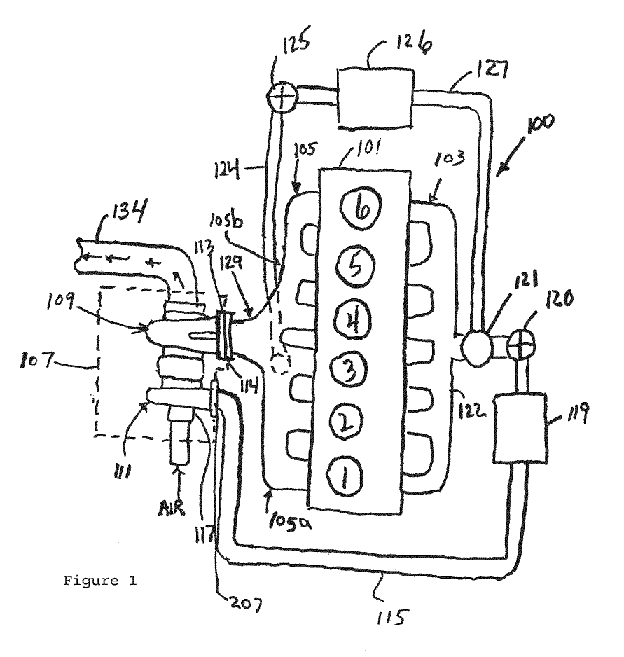

An engine 100 is shown schematically in FIG. 1. The engine 100 has a block 101 that includes a plurality of cylinders. The cylinders in the block 101 are fluidly connected to an intake system 103 and to an exhaust system 105. The exhaust system includes a first pipe 105a from cylinders 1, 2 and 3 of one bank of cylinders and a second pipe 105b from cylinders 4, 5 and 6. Although an inline arrangement of six cylinders is illustrated, inline or V-arrangements or other arrangements of plural cylinders of any number of cylinders are also encompassed by the invention.

A turbocharger 107 includes a turbine 109. The turbine 109 shown has a single turbine inlet port 113 connected to the exhaust system 105. The turbocharger 107 includes a compressor 111 connected to the intake system 103 through an inlet air passage 115.

During operation of the engine 100, air may enter the compressor 111 through an air inlet 117. Compressed air may exit the compressor 111 through an outlet 207, pass through the inlet air passage 115, and pass through an optional charge air cooler 119 and an optional inlet throttle 120 before entering an intake air mixer 121 and an intake air manifold 122 of the intake system 103. The compressed air enters the engine cylinders 1-6.

A stream of exhaust gas from the exhaust system 105 may be routed through an exhaust gas recirculation (EGR) passage or conduit 124, through an EGR valve 125, through an EGR cooler 126 and pass through a further EGR conduit 127 before meeting and mixing with air from the inlet throttle 120 at the mixer 121.

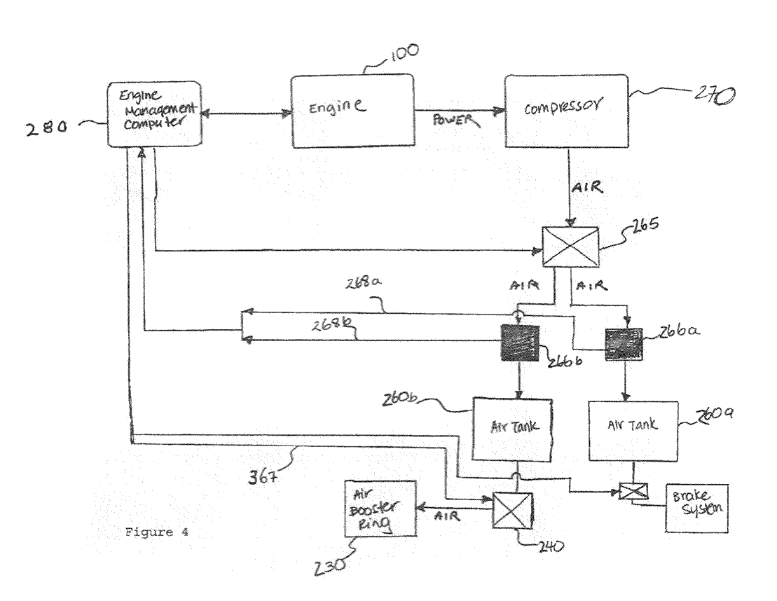

The inlet port 113 of the turbine 109 may be connected to the exhaust pipes 105a, 105b in a manner that forms a distribution manifold 129 (FIG. 4). Exhaust gas passing through the turbine 109 may exit the engine 100 through a tailpipe 134. Emissions and sound treating components can be arranged to receive the exhaust gas from the tailpipe, before exhausting to atmosphere, as is known.

At times when the EGR valve 125 is at least partially open, exhaust gas flows through pipes 105a, 105b through the conduit 124, through the EGR valve 125, through the EGR cooler 126, through the further conduit 127 and into the mixer 121 where it mixes with air from the inlet throttle 120. An amount of exhaust gas being re-circulated through the EGR valve 125 may depend on a controlled opening percentage of the EGR valve 125.

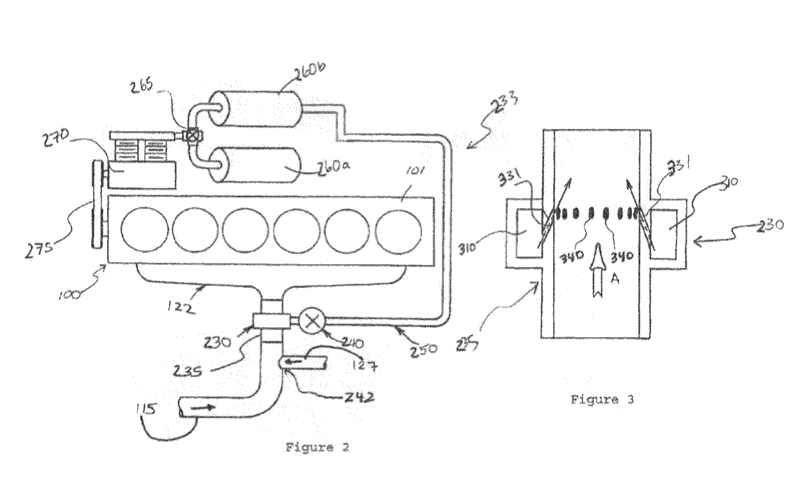

FIG. 2 illustrates an internal combustion engine 100, preferably a diesel engine, using an inlet air booster system 233 according to an exemplary embodiment of the invention. Compressed air from the turbo charger enters the intake manifold 122 via the inlet air passage 115. EGR flow is carried towards the inlet air passage 115 via the conduit 127, and intersects with the inlet air passage 115 at an EGR intersection 242 or alternately in a mixer 121, as shown in FIG. 1. The booster system 233 provides for a boost of air into a manifold inlet supply pipe 235 downstream of the EGR intersection 242. The booster system 233 comprises an inlet air booster ring 230, a control valve 240, and an air supply source.

The air supply source comprises compressed air in an air tank 260b, which flows along a compressed air supply pipe 250 to reach the inlet air booster ring 230. An air compressor 270 provides compressed air to air brake tank 260a and air tank 260b. The compressor 270 is powered by the engine 100 via a driving mechanism 275, which can be a belt connected to the crankshaft pulley, or directly off of the engine timing gears. Air exiting the air compressor 270 is regulated by an air tank valve assembly 265 to enter into either air tank 260a, or air tank 260b. Additional air tanks can be provided for additional auxiliary systems in the vehicle, which can be regulated by additional valves. Air tank 260a is an air tank for storing pressurized air for operating air braking mechanisms in the vehicle, or for operating additional systems in the vehicle. Pressure sensors 266a, 266b (FIG. 4) are used to measure the air pressure in air tanks 260a and 260b respectively. Air pressure in air tank 260a for braking systems in the vehicle is usually maintained at 120 psi. Excess compressed air not needed to maintain the air tank 260a pressure at 120 psi is channeled into air tank 260b via air tank valve assembly 265 as part of the air supply source for the inlet air booster system.

Air tank valve assembly 265 regulates the flow of air from air tank 260b to compressed air supply pipe 250. Alternatively, a different valve can be used to regulate the flow from the air tank 260b to the compressed air supply pipe 250. The air supply pipe carries the compressed air to the air booster ring 230. Flow of compressed air to the air booster ring 230 is regulated using a control valve 240, disposed along the compressed air supply pipe 250 upstream of the air booster ring 230. The control valve 240 is preferable a high volume control valve, and controlled by the engine management computer (EMC). Compressed air flows along the compressed air supply pipe 250 to the air booster ring 230 when the EMC 280 (FIG. 4) sends a signal to activate, or open the control valve 240. The inlet air booster system does not restrict normal gas flow of the engine or otherwise interfere with normal engine operations when not in use.

Once air reaches the air booster ring, it enters the manifold inlet supply pipe 235 via a plurality of circumferentially arranged nozzles. FIG. 3 illustrates a cross sectional view of the air booster ring 230. The air booster ring comprises annular air space 310 disposed around the circumference of the manifold inlet supply 235. Compressed air from air tank 260b flows through compressed air supply pipe 250 to enter annular air space 310.

Compressed air enters the manifold inlet supply 235 from the annular air space 310 via nozzles 331 which are arranged in a ring around the circumference of the manifold inlet supply 235. Nozzles 331 are angled such that compressed air flowing through the nozzles is directed downstream toward the intake manifold. In other embodiments, more than one ring of nozzles 331 can be arranged around the circumference of the manifold inlet supply 235 to provide a boost of air into the intake manifold 122. Compressed air exits the nozzles 331 at outlets 340 which appear elliptical as a result of the angled arrangement of the nozzles 331. Nozzles can be angled, for example, at 20 degrees from a longitudinal axis parallel to the manifold inlet supply pipe 235. Other suitable nozzle arrangements, such as the use of tubes of a different diameter, or a different number or position of tubes can be used as known to one skilled in the art.

Without wishing to be bound by any particular theory, it is believed that the nozzles so angled, in the direction of downstream flow, releases a strong gust of compressed air in the direction of flow A to create a low pressure vacuum which encourages an increased flow of air into the intake manifold. The angled nozzles provides a high pressure boost of air which draws additional intake air in the direction of flow A, which prevents the need to close the EGR valve 125 (FIG. 1) to prevent back flow.

Using the inlet air booster system of the present invention, the engine launch off idle would require a short 1 to 2 second burst of air to allow the turbocharger to reach sufficient speed to build its own boost. This system would therefore require a rapid blow-down of the tank into the booster accomplished through a high speed, high flow control valve 240 controlled by the EMC.

In operation, the EMC acts as a central control system which monitors various components of the internal combustion engine. The air compressor 270 provides a flow of compressed air to either tanks 260a or 260b as regulated by air tank valve assembly 265 which is controlled by the EMC. Pressure sensors 366a and 366b as illustrated in FIG. 4 send signals 268a, 268b relaying information pertaining to pressure in tanks 260a and 260b respectively. When pressure in air tank 260a for the vehicle braking system is at 120 psi, compressed air from air compressor 270 is regulated by air tank valve assembly 265 to enter air tank 260b which serves as an air supply for the inlet air booster system. The EMC can regulate additional air tanks for other auxiliary systems in a similar fashion. When the EMC senses that a driver is depressing the accelerator pedal to accelerate from idle, the EMC 280 sends an activation signal 367 (FIG. 4) to activate the inlet air booster system by opening control valve 240 to allow air to flow to the air booster ring 230 to provide a burst of compressed air into the intake manifold 122.

### PARTS LIST

100 engine
101 block
103 intake system
105 exhaust system
105a first exhaust pipe
105b second exhaust pipe
107 turbocharger
109 turbine
111 compressor
115 inlet air passage
119 optional charge air cooler
120 optional inlet throttle
121 inlet air mixer
122 intake manifold
124 EGR conduit
125 EGR valve
126 cooler
127 further conduit
129 distribution manifold
134 tailpipe
207 tangential discharge nozzle
230 air booster ring
233 inlet air booster system
235 manifold inlet supply pipe
240 control valve
242 EGR intersection
250 compressed air supply pipe
260a air tank for brake system
260b air tank for inlet air booster system
265 air tank valve assembly
268a, 268b pressure signal
270 air compressor
275 driving mechanism
310 annular air space
331 nozzle
340 outlet
367 activation signal

From the foregoing, it will be observed that numerous variations and modifications may be effected without departing from the spirit and scope of the invention. It is to be understood that no limitation with respect to the specific apparatus illustrated herein is intended or should be inferred.

All references, including publications, patent applications, and patents, cited herein are hereby incorporated by reference to the same extent as if each reference were individually and specifically indicated to be incorporated by reference and were set forth in its entirety herein, except where inconsistent with the present disclosure.

1. An inlet air booster system for an internal combustion engine, the internal combustion engine having an air inlet conduit, comprising:
an air supply source in fluid communication with the air inlet conduit;
a control valve in the air supply source; and
a plurality of air nozzles in fluid communication between the air supply source and the inlet conduit.

2. The system according to claim 1 wherein the air supply source comprises an air tank in fluid communication with a compressed air supply pipe.

3. The system according to claim 2 wherein the air tank is pressurized with air by an engine driven compressor.

4. The system according to claim 3 wherein the air from the engine driven compressor is waste air from an air tank supplying air to an air brake system.

5. The system according to claim 1 wherein the plurality of nozzles are in fluid communication with an air source comprising an annular air chamber.

6. The system according to claim 1 wherein the plurality of nozzles comprises at least three circumferentially spaced nozzles.

7. The system according to claim 6 wherein the nozzles are disposed at an angle towards the direction of downstream flow of intake gases.

8. The system according to claim 7 wherein the nozzles are disposed at an acute angle to the flow of intake air through the inlet supply pipe, and having a velocity direction component toward the downstream direction.

9. A method of operating an internal combustion engine having a turbocharger and an engine-driven compressor that supplies pressurized air into an engine intake, comprising the steps of:
providing a supply of pressurized air within a tank;
delivering the pressurized air to the intake when a demand is made on the engine.

10. The method of claim 9 wherein the step of delivering the pressurized air comprises the step of injecting air into a supply pipe in multiple streams, the streams being circumferentially spaced around the supply pipe.

11. The method of claim 10 wherein the streams are arranged to have a velocity direction that is at an acute angle to the flow of intake air through the inlet supply pipe, and having a velocity direction component toward the downstream direction.

12. The method of claim 11 further comprising the step of providing an increased flow of air into the intake manifold as a result of lower pressure generated by the downstream velocity direction of the streams.

13. The method of claim 10 wherein the pressurized air is supplied to an annular air chamber prior to its injection into the supply pipe.

14. The method of claim 9 wherein the step of delivering the pressurized air is regulated by control valve.
